(19) United States
(12) Patent Application Publication
(10) Pub. No.: US 2010/0332192 A1
(43) Pub. Date: Dec. 30, 2010

(54) Method and Tools for Self-Describing Data Processing

(75) Inventors: Bruce Y. Lin, New Orleans, LA (US); John T. Sample, Pearl River, LA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(73) Assignee: The Government of the United States of America, as represented by the Secretary of the Navy, Washington, DC (US)

(21) Appl. No.: 12/767,871

(22) Filed: Apr. 27, 2010

Related U.S. Application Data
(60) Provisional application No. 61/172,807, filed on Apr. 27, 2009.

(51) Int. Cl. G06F 15/00

(52) U.S. Cl. 702/189

(57) ABSTRACT

A data set can self-describe a set of data specifications that describe the physical measurements, spatial representation, and file format of data stored in the data set. A data processing tool can self-describe a set of input specifications of the physical measurements, spatial representation, and file storage format of data that can be accepted for processing by the tool. Fully automated methods for coordinating the processing and analysis of the data set by the data processing tool are presented which ensure that the data input to a data processing tool represents the proper physical measurements, has the proper spatial representation, and is in the proper file format to permit the data processing tool to produce logically correct output.

### CROSS-REFERENCE

This application claims the benefit of priority based on U.S. Provisional Patent Application No. 61/172,807 filed on Apr. 27, 2009, the entirety of which is hereby incorporated by reference into the present application.

### TECHNICAL FIELD

The present invention relates to coordination of processing and interchange of data between modules in a mixed software environment.

### BACKGROUND

Rapid, efficient analysis of data continues to be essential in both the civilian and the military sphere. Typical sensor-driven processing systems collect large amounts of data that must be analyzed and processed to provide the necessary information to perform a mission, complete a task, and/or achieve a goal. However, the data that is ingested into the data domain often are in different formats, with different metadata, or with other properties that can hinder the data-processing system's ability to quickly and accurately process the data to provide a usable result. In addition, the processed data often is not an end product in itself but is in turn input into other systems, and so in order to be useful, the processed data often must be in a form that is compatible with the next system in the data-processing chain.

For example, the Navy collects a myriad of data from numerous sensor sources, both during missions specifically intended to collect data and during other operations. This data is collected from sources such as such as sonobuoys, sidescan and multibeam sonar, fathometer, electro-optical imaging and manually collected measurements, and includes underwater environmental data such as seafloor characteristics, ocean properties, and atmospheric properties. In addition, the data to be analyzed can be both historical data, i.e., previously collected data representing the environment at a previous point in time, and dynamic, real-time data, representing the environment at or near the time of analysis. The contents of a particular data set, both the type of physical measurement represented by the data (e.g., bathymetry, temperature, salinity, etc.) and its geospatial representation (points, lines, polygons, etc.) are intrinsic properties of the data, while the binary storage format (comma-separated text, NetCDF, ESRI Shape, SVG, etc), file name, and file organization, are generally considered to be “extrinsic” properties. See Erich Gamma et al., Design Patterns: Elements of Reusable Object-Oriented Software (1995). Thus, each data set can be characterized by the physical measurements it represents, its spatial representation, and data storage format.

The Navy's post-mission analysis (PMA) of the data that it collects has a basic three-stage process. First, the sensor data is ingested from a raw, sometimes proprietary format. Second, the ingested data goes through one or more analysis steps, which may involve a human operator or an automated processing algorithm, and result in one or more derived data products. Finally, the data product(s) are exported to an external source, archived, or posted in a discoverable form. See John P. Stenbit, “Department of Defense Net-Centric Data Strategy,” May 9, 2003, Department of Defense memorandum, http://www.dod.mil/nii/org/cio/doc/Net-Centric-Data-Strategy-2003-05-092.pdf.

Combining historical and dynamic data to generate a useful product such as a representative environment from these data requires advanced data fusion techniques. Michael Harris, et al. “Environmental Data Collection, Sensor to Decision Aid,” in Sixth International Symposium on Technology and the Mine Problem, May 9-13, 2004. Early PMA systems used a tool-chain of software programs. Each software component was specifically bound to not only to binary file format, but also to the representation of data within the format. An expert operator, aware of the capabilities of each software program, would be required to manually execute the program to generate the desired product.

For example, bathymetry (water depth) soundings are geometrically represented as a series of points in three-dimensions: latitude, longitude, and depth. These data can be stored in a file such as a comma-separated text file, whose format preserves the data content but relies on the operator to retain the data context. The bathymetry data can then be input into a bathymetry interpolation program that accepts comma-separated values and applies a tide correction shift to the point values and to produce a gridded bathymetry product with evenly spaced, averaged bathymetry values over a given geographic area. A different environmental parameter, sea surface temperature, may be encoded in the same format as point values in comma-separated text and also input into the bathymetry interpolation program. The bathymetry interpolation process has no way to discriminate the input types, yet applying it to the temperature data creates nonsense output. The discrimination between these two environmental parameters is left to the operator, slowing down the process considerably, and limiting the ability of the system to rapidly, efficiently, and accurately process large sets of data.

Given this view of the data, a methodology for describing these intrinsic and extrinsic properties and allowing the processing components to self-describe their input-output interfaces greatly enhances the level of processing automation, error control, and context-awareness in the PMA software system.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present invention provides fully automated methods for coordinating the processing and analysis of data from disparate data sources to ensure that the data input to a data processing tool represents the proper physical measurements, has the proper spatial representation, and is in the proper file format to permit the data processing tool to produce the logically correct output. The present invention also permits the fully automated integration of multiple data processing tools, for example, individual data processing modules in an integrated data processing system, into a single platform that can process and analyze data from disparate data sources to produce appropriate output.

In accordance with the present invention, a data set can include a set of self-described data specifications defining the data in the data set. The data specifications can include a definition of a data type, e.g., a physical measurement represented by the data in the data set, a definition of a spatial representation of the physical measurement represented by the data, and a definition of a file storage format in which the data is stored on a medium.

The data set is available for processing by a data processing system which can include one or more data processing tools. In accordance with the present invention, each data processing tool can have a set of self-described input specifications defining the input data that it will accept for processing. Thus, for example, a data processing tool can include self-described input specifications defining the acceptable data type, e.g., a physical measurement represented by acceptable input data, a spatial representation of acceptable input data, and a file storage format of acceptable input data. The set of input specifications can be incorporated into the data processing tool itself or can be externalized as a portable configuration file that is operatively associated with the data processing tool.

The data processing tool also can have a set of output specifications defining the data specifications of the output data that it will produce, including definitions of the output data type, e.g., the physical measurement represented by the output data, the spatial representation of the output data, and the file format of the output data. The output specifications may be the same as the input specifications or they may be different, thus enabling the conversion of input data having a first set of data specifications into output data having a second set of data specifications.

In addition, in some embodiments, the data processing tool can comprise one module in an integrated data processing system containing multiple modules, where the output data from a first data processing tool may in turn be input into a second data processing tool which also has defined the characteristics of the input data that it will accept, and so on until the original data set is processed to its final output.

In other embodiments, at any stage in the processing of the data set, an appropriate data processing tool having input specifications that are compatible with the data specifications of the data set can be automatically selected from among multiple possible data processing tools in the data processing system.

The present invention can also provide a method for validating a data set for use with a data processing tool. Because a data processing tool can include a set of input specifications defining the physical measurement, the spatial representation, and the file storage format of data that it will accept for processing, a data set having a set of data specifications that is not compatible with the processing tool's input specifications can be rejected by the data processing tool, thus preventing the unnecessary processing of data that would generate nonsense or otherwise unusable results. In other embodiments, a data set having one or more data specifications which are not compatible with the corresponding input specifications of a data processing tool can be automatically converted into a revised data set whose data values remain unchanged but having revised data specifications that are compatible with those of the data processing tool so that the data can be processed rather than be rejected.

In some cases, the data specifications of a data set can automatically be set based on the source of the data. In other cases, if one or more of the data specifications is set, the remaining specifications can automatically be set, for example, to ensure that the set of data specifications as a whole will enable the data to be processed and produce useful output.

The present invention also includes one or more data processing tools, including a tool that can examine the input specifications of a data processing tool in a data processing system and the data specifications of a data set received for input into the data processing system and accept, reject, or modify the data set so that only a data set that can produce appropriate output is processed by the data processing system.

### BRIEF DESCRIPTION OF THE DRAWINGS

FIG. 1 depicts aspects of exemplary data specifications and an exemplary data type triplet that can be used in accordance with the present invention.

FIG. 2 depicts aspects of an exemplary data type specification that can be implemented in a data processing tool in accordance with the present invention.

FIG. 3 depicts an exemplary logic flow that can be used by a data processing tool in accordance with some embodiments of the present invention.

FIG. 4 depicts an exemplary logic flow that can be used by a data processing tool in accordance with other embodiments of the present invention.

FIG. 5 depicts an exemplary logic flow that can be used by a data processing tool in accordance with still other embodiments of the present invention.

FIG. 6 depicts an exemplary application of a method for data processing in accordance with the present invention.

### DETAILED DESCRIPTION

The aspects and features of the present invention summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

The present invention provides a computer-implemented method for automatically organizing the processing of data from disparate data sources using disparate data processing tools to ensure that the resulting output is logically coherent and useful from an operational viewpoint. As will be appreciated by one skilled in the art, a method for automatically facilitating the processing of data in accordance with the present invention can be accomplished by executing one or more sequences of instructions contained in computer-readable program code read into a memory of one or more general or special-purpose computers configured to execute the instructions, wherein a data set can be input into a data processing tool and transformed into useful output data, where both the input and the output data represent a physical measurement and where both the input and the output data as well as the data processing tool have a specific set of parameters defining, for example, the type of physical measurement represented by the data, the spatial representation of the physical measurement within the data set, and the data storage format for storage of the data on a physical medium.

The present invention provides fully automated methods for coordinating the processing and analysis of data from disparate data sources to ensure that the data input to a data processing tool represents the proper physical measurements, has the proper spatial representation of those measurements, and is in the proper file format to permit the data processing tool to produce logically correct output. The present invention also permits the fully automated integration of multiple data processing tools, for example, individual data processing tools in a larger data processing system, into a single platform that can process and analyze data from disparate data sources to produce appropriate output.

In accordance with the present invention, a data set can include a set of data specifications defining the data in the data set. The data specifications can include a definition of intrinsic properties of the data set such as the physical objects that are the subject of the data set or a definition of extrinsic properties of the data set such as a software package in which the data set is used, or a combination of both types of properties. Thus, in an exemplary embodiment described herein, the data specifications of a data set can define a physical measurement represented by the data, a spatial representation of the physical measurement represented by the data, and the file storage format in which the data is stored on a medium.

The data set is available for processing by a data processing system which can include one or more data processing tools. In accordance with the present invention, each data processing tool can have a set of input specifications defining the intrinsic and extrinsic properties of input data that it will accept for processing. Thus, an exemplary data processing tool described herein can include input specifications defining the physical measurement represented by acceptable input data, the spatial representation of acceptable input data, and the file storage format of acceptable input data.

The data processing tool also can have a set of output specifications defining the output data that it will produce, such as definitions of the physical measurement represented by the output data, the spatial representation of the output data, and the file format of the output data. The output specifications may be the same as the input specifications or they may be different, thus enabling the conversion of input data having a first set of characteristics into output data having a second set of characteristics.

Thus, the present invention includes two main aspects. The first is a specification of the intrinsic and extrinsic properties of the data in a data set, referred to herein as the data specifications of the data set. The second is the definition by a data processing tool of the intrinsic and extrinsic properties of data that are acceptable for processing by the tool. In accordance with the present invention, a data processing tool can compare the data specifications of the data set with the input specifications of the data processing tool and take one or more actions as a result of that comparison.

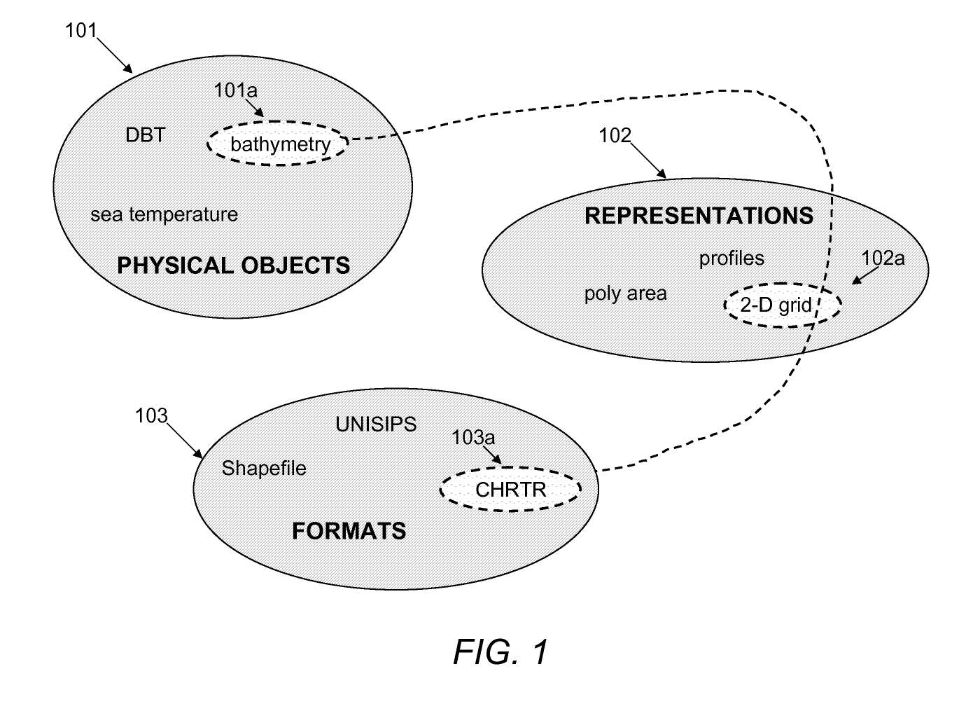

FIG. 1 illustrates aspects of data specifications of a data set in accordance with the present invention. As described above, a data set can be described as including data specifying intrinsic properties of the data such as a physical measurement 101 represented by the data and a spatial representation 102 of the physical measurement as well as extrinsic properties such as a file storage format 103 for storage of the data on a physical medium. A set of data specifications, which also can be known as a “data type triplet” is a combination of one value from each of these properties. Each set is a collection of mutually exclusive values, from which a set of relations can be drawn. For example, as shown in FIG. 1, a data set can contain a set of bathymetry values 101a, that are represented in a 2-D grid 102a, with the data stored in a CHRTR 103a data storage format. In some cases, the data specifications are automatically assigned to the data set based on a source of the data in the data set, while in other cases they are heuristically inferred from the data set contents.

It should be noted that not all relations between a physical measurement, a spatial representation, and a data storage format are valid. An example of a nonsense triplet would be sea temperature as polygonal areas stored in CHRTR format. Such a triplet would not allow the data set to provide useful results because the data storage format CHRTR cannot encode polygon shapes.

The set of physical measurements, geospatial representations of those physical measurements, and file formats that can be accepted for processing by a data processing tool and the permissible combinations thereof comprise a set of input specifications of the data processing tool. The input specifications can be included as part of the data processing tool itself or can be implemented using a type-driven plug-in system. This data type signature of the data processing tool is declared and stored within the type-driven plug-in system. The system later uses this input-output signature to recall plug-ins that satisfy a processing need.

For example, in some embodiments in accordance with the present invention, the inspection and selection of an appropriate data set can be performed by a generic module interface that allows for the following basic capabilities:

Inspection of input specifications of a data processing tool
Inspection of output specification of the data processing tool
Inspection of data specifications of data for input into the data processing tool
Execution of the data processing tool with appropriate data
Collection of output data

This methodology allows a significant decoupling of the invoking application from the external process without requiring the operator to retain or exercise knowledge of the intrinsic properties of the input/output data types. The execution environment, for example, the Navy's Environmental Post-Mission Analysis (EPMA) system, can use the knowledge of the specification, and use an inspection of each module to enforce type compatibility at a logical level. Such an interface can be implemented using the C++ programming language using the Qt 4.3 open source library to facilitate compiled library loading, though any programming language supporting interface constructs and run-time loading of external libraries can be used, such as the Java programming language.

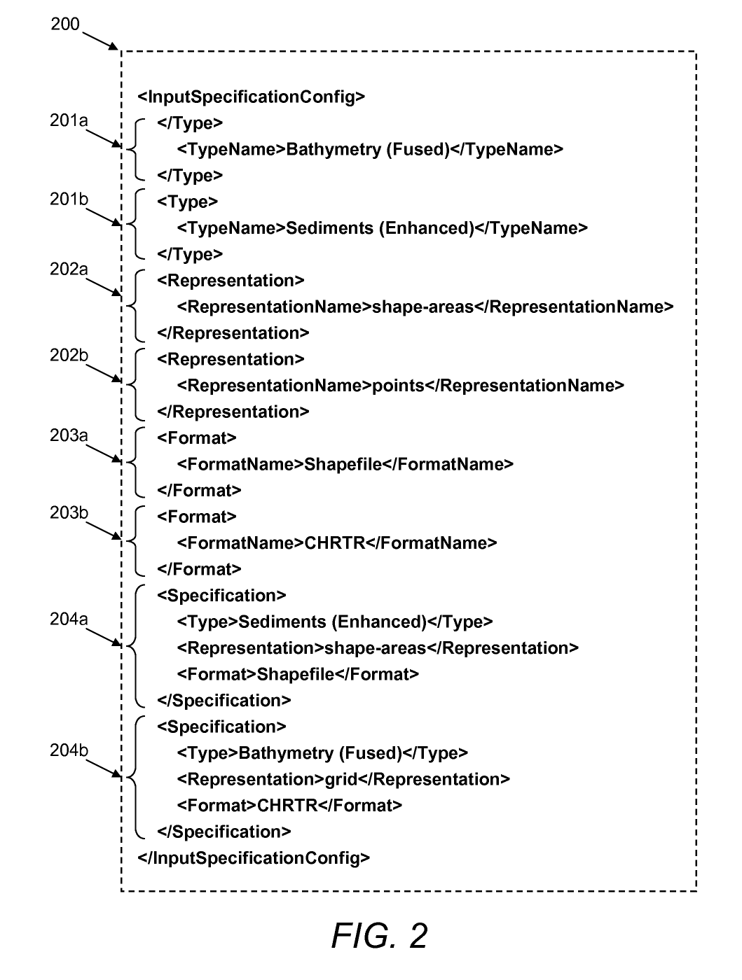

For example, the input specifications can be set forth in a portable XML file containing the specifications such as the exemplary set of input specifications illustrated in FIG. 2. As shown in FIG. 2, an input specification configuration 200 for a data processing tool can define the data that can be accepted by the tool. Thus, as shown in FIG. 2, the data specification for a data processing tool can set the acceptable data types, i.e., the physical measurements of acceptable data, to be Bathymetry (Fused) 201a and Sediments (Enhanced) 201b, acceptable representations, i.e., the geospatial representations of the physical measurements to be shape-areas 202a and points 202b, and the acceptable data storage formats for the input data to be a Shapefile format 203a and a CHRTR format 203b. The data specification can then define the combinations of the data type, representation, and format that must be present in a data set accepted for input into the data processing tool, such as the combination 204a of data type Sediments (Enhanced), representation shape-areas, and format Shapefile or the combination 204b of data type Bathymetry (Fused), representation grid, and format CHRTR. Only data sets having data specifications that are compatible with one or the other of the input specifications of the data processing tool can be accepted for processing by the tool.

In some embodiments, the data processing tool can also include a similar set of data specifications defining, for example, combinations of data type, representation, and storage format of data that are output by the data processing tool, and this definition of the output data can be used to determine whether that output data can be input into another data processing tool in an integrated data processing system.

In addition, in some embodiments, such a data processing tool can comprise an intermediate tool that can be used to convert an otherwise incompatible data set, e.g., one having an incompatible representation specification, to a data set having a set of data specifications that is compatible with the data processing system.

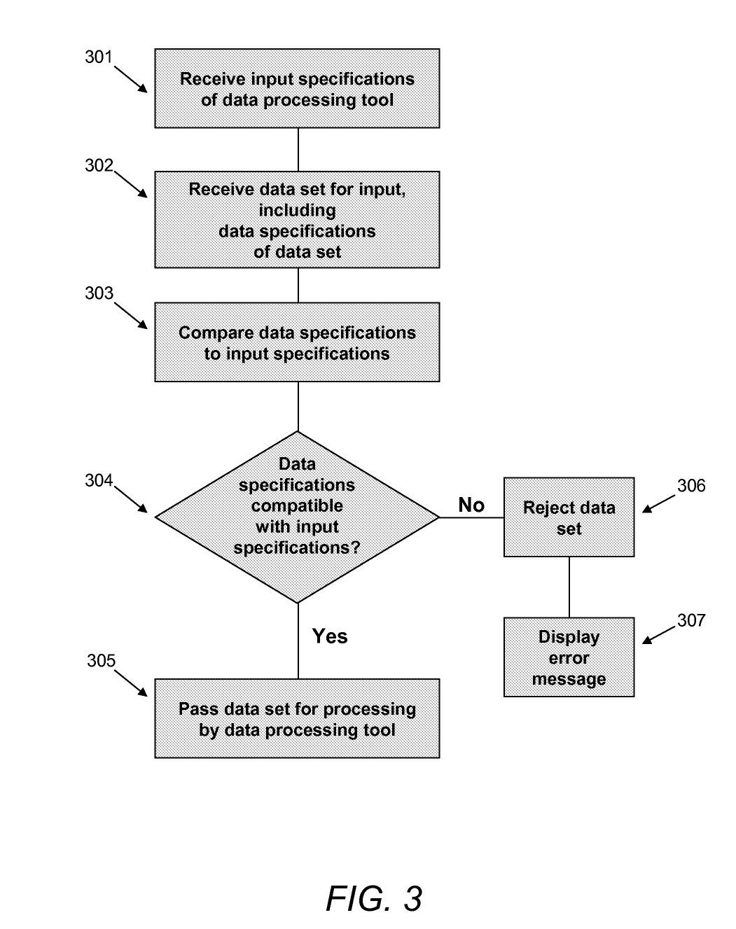

Exemplary logic flows for various exemplary embodiments of methods for self-describing data processing in accordance with the present invention are illustrated in FIGS. 3-5.

In a first exemplary embodiment illustrated in FIG. 3, the present invention includes a method for automatically identify compatible data set(s) for processing by a data processing tool.

As shown in FIG. 3, a method for selecting a data set in accordance with this embodiment of the present invention can begin at step 301, where a computer including a processor programmed to execute a data processing tool can receive a set of self-defined input specifications defining acceptable data that can be input into the data processing tool, the set of input specifications including a specification of a physical measurement represented by the acceptable data, a specification of a geospatial representation of the physical measurement represented by the acceptable data, and a specification of a data storage format in which acceptable data can be stored. As noted above, the set of input specifications can either be incorporated into the data processing tool itself or can be externalized as a portable configuration file operatively associated with the data processing tool.

At step 302, a data set for input into the data processing tool can be received, the data set including a set of data specifications defining the data in the data set, where the data specifications include a physical measurement represented by the data in the data set, a geospatial representation of the physical measurement represented by the data, and a data storage format in which the data in the dataset is stored on a storage medium. At step 303, the processor can compare the input specifications to the data specifications of the data set and at step 304 can inquire whether the data specifications of the data set are compatible with the input specifications of the data processing tool. If the answer to the question at step 304 whether the data specifications are compatible with the input specifications is “Yes,” the data set can be accepted for processing and at step 305 can be passed to the data processing tool for processing. If, however, the answer at step 304 is “No,” the data set can be rejected at step 306, and will not be processed by the data processing tool. This is especially critical in cases where incompatible data would unconditionally processed by the tool, corrupting subsequent stages and silently producing an incorrect output. In some embodiments, at optional step 307, an error message can be displayed on a display operatively connected to the processor, where the error message can provide information to a user regarding the rejection of the data set and the reasons for the rejection, such as identifying the incompatible input specification and data specification and/or providing suggestions for a remedy.

As noted above, in some embodiments, the data processing tool can also include a set of output data specifications defining data that is output from the data processing tool, the set of output data specifications including a specification of a physical measurement represented by the output data, a specification of a geospatial representation of the physical measurement represented by the output data, and a specification of a data storage format for storage of the output data. In this embodiment, in some cases the data set will be accepted for processing by the data processing tool only if it can produce data compatible with the output specifications.

In some embodiments, the data processing tool can also be a part of an integrated data processing system made up of multiple data processing modules, where the output from one data processing tool in an integrated data processing system can be input for another data processing tool in the system. In such embodiments, the output data set from the first data processing tool can have a set of output data specifications as defined by the first data processing tool and the second data processing tool can have a set of its own input specifications, which, like the input specifications of the first data processing tool, can define acceptable data that can be input into the tool for processing. The output data specifications of the output data set from the first data processing tool can then be inspected and compared to the input specifications of the second data processing tool in a manner similar to that described with respect to FIG. 3, with the output data set from the first data processing tool being accepted as input into the second data processing tool only if the output data specifications of the output data set are compatible with the input specifications of the second data processing tool.

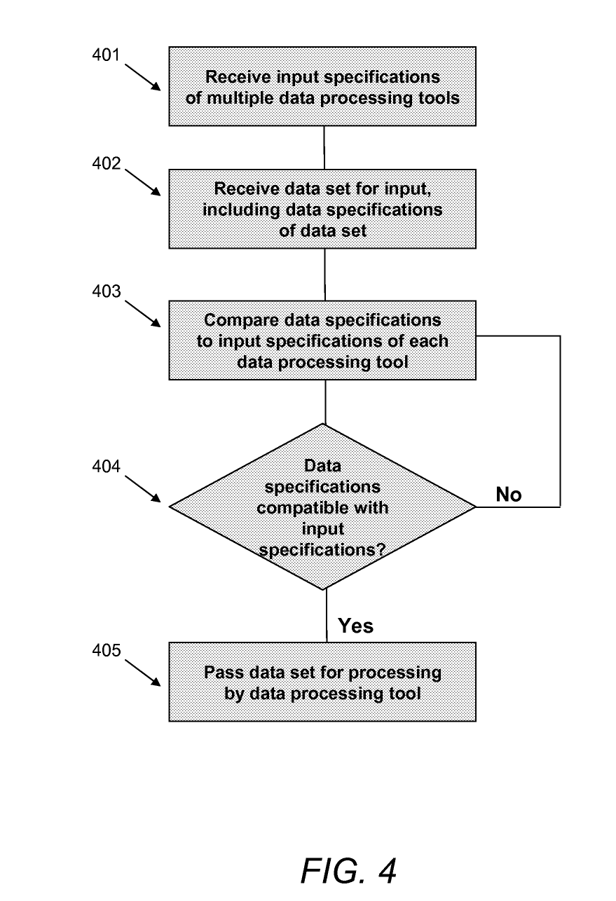

In another embodiment of a method for data processing in accordance with the present invention, an appropriate data processing tool can be automatically selected from several possible tools in a data processing system based on the data specifications in a data set. An exemplary processing flow in accordance with this embodiment is illustrated in FIG. 4.

As shown in FIG. 4, at step 401, a computer including a processor programmed to operate in a data processing system and execute a plurality of data processing tools can receive a plurality of self-defined input specifications for a corresponding plurality of data processing tools, where each set of input specifications defines acceptable data that can be input into the corresponding data processing tool and where, as described above, each set of input specifications includes a specification of a physical measurement represented by the acceptable data, a specification of a geospatial representation of the physical measurement represented by the acceptable data, and a specification of a data storage format in which acceptable data can be stored.

At step 402 shown in FIG. 4, the computer can receive a data set for processing by the data processing system, the data set including a set of data specifications defining the data in the data set, the data specifications including a physical measurement represented by the data in the data set, a geospatial representation of the physical measurement represented by the data, and a data storage format in which the data in the dataset is stored on a storage medium. At step 403, the processor can inspect the data specifications of the data set and compare the data specifications of the data set to the input specifications of one of the data processing tools in the data processing system. At step 404, the computer can inquire whether the data specifications of the data set are compatible with the input specifications of the data processing tool. If the answer at step 404 is “Yes,” i.e., the data specifications of the data set are compatible with the input specifications of the data processing tool, then the data set can be passed to the data processing tool for processing. If on the other hand the answer at step 404 is “No,” then the processor can return to step 403 and compare the data specifications of the data set to the input specifications of a different one of the plurality of data processing tools in the data processing system. In this way, the data set can automatically be passed to an appropriate data processing tool out of multiple possible data processing tools, with the result that the a complete processing chain can be executed with no external user input.

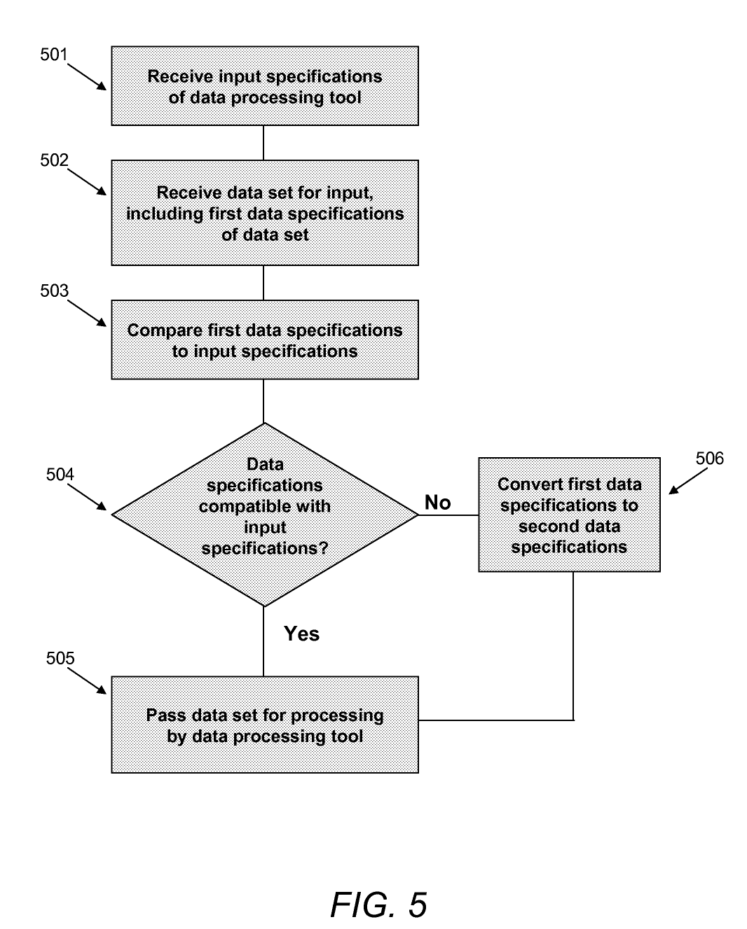

Another embodiment of the present invention, which can be executed using the exemplary logic flow illustrated in FIG. 5, can provide a method for automatically converting data that is incompatible with a data processing tool into data that is compatible and may be processed by the data processing tool without any modification of the tool itself.

As shown in FIG. 5, at step 501, as with the previous embodiments described above, a computer programmed to execute a data processing tool can receive a set of input specifications of the data processing tool which, as described above, define acceptable data that can be input into the tool. At step 502, as with the previous embodiments described above, the computer can also receive a data set for processing by the data processing tool, with the data set including a set of first data specifications defining the data in the data set in a manner described above. At step 503, the processor can inspect the input specifications of the data processing tool and compare those input specifications to the first data specifications of the data set and at step 504 can inquire whether the data set's first data specifications are compatible with the processing tool's input specifications. If the answer at step 504 is “Yes,” then at step 505 the processor can pass the data set to the data processing tool for processing. If, on the other hand, the answer at step 504 is “No,” instead of rejecting the data set, at step 506, the processor can automatically convert the incompatible first data specifications into a set of second data specifications which are compatible with the data processing tool's input specifications, and the converted data set can then be passed to the data processing tool at step 505. In this way, process automation is achieved by the system automatically inferring which intermediate plug-ins are needed, strictly by input/output compatibility. In some embodiments, this process can occur as part of the data processing tool itself, while in other embodiments, the inspection and conversion of the data set's data specifications can be performed by a separate module in a larger data processing system that is situated between a data input and the data processing tool. In addition, the conversion of the data specifications from a first set to a second set can occur as many times as may be necessary to convert a data set from one that is not compatible with the data processing tools in a data processing system into one that is compatible.

As noted above, in some embodiments of the present invention, the data specifications of the data set can be automatically populated based on a source of the data set. For example, the “Bathymetry Attributed Grid” or “BAG” format has a specific naming convention. All BAG files possess a “.bag” extension, contain bathymetry measurements, represented as a grid of points. Any data file that is suffixed with “.bag” can be inferred to have this specific type triple. In addition, as noted above, not all combinations of data specifications make logical sense. For example, acoustic image representation of the seafloor can neither be represented by polygon features, nor can it be persisted in a “Shapefile” format. In some such cases, data of only one data specification of the data set need be received by the computer, and the other data specifications can be automatically set so that they are compatible with the data processing tool. Formally, this is possible only when a particular value of a data specification occurs once and only once in the set of possible data type triples. The incidence of unique data specification values, and thus, automatic type inference, can be improved by increasing refining the granularity of the data specification values. For example, “bathymetry” may be persisted in several formats and geometric representations. “Fused Bathymetry” however, implies a specific format, i.e., “CHRTR,” and a specific representation, i.e., “gridded.”

The present invention also can include a data input tool for carrying a method for receiving and inputting a data set into a data processing system in accordance with one or more aspects described herein. Such a data processing tool can include a data processing tool definition module which includes a set of input specifications defining acceptable data that can be input into a data processing tool and a data inspection module configured to inspect the data set to determine whether the data specifications of the data set are compatible with the input specifications of the data processing tool, so that the data set can be passed for processing by the data processing system only if all the data specifications of the data set are compatible with the input specifications of the data processing tool.

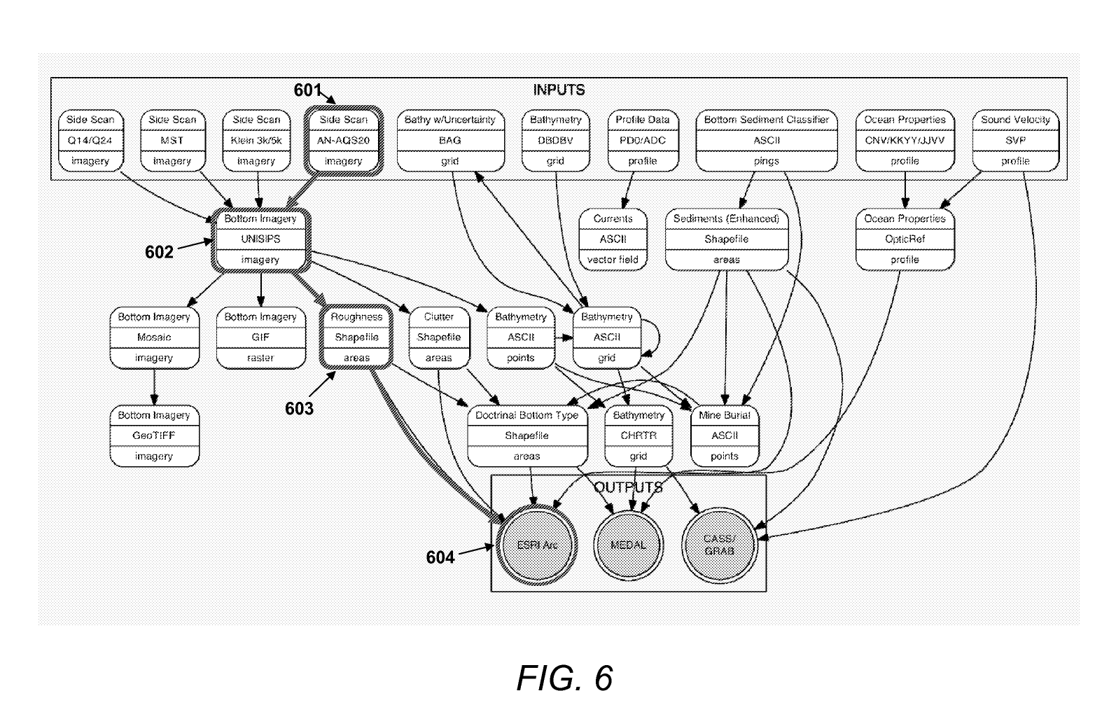

FIG. 6 depicts aspects of an exemplary application of a method for self-describing data processing in accordance with the present invention. As shown in FIG. 6, a number of different raw data sets can be available for input into a data processing system from a number of different inputs, and each has its own set of metadata that describes the kind of data in the data set. For example, the raw data set 601 shown in FIG. 6 comprises Side Scan imagery that is stored in AN-AQS20 format. As described above, however, this description of the data, however, may not always permit the data to be processed by a data processing tool which may require a different description of the same data in its input specification. Thus, as shown in FIG. 6, using a data conversion tool and the methods for self-describing data processing as described herein, the raw data set 601 can be converted to a second data set 602, which now is self-described as containing physical measurements comprising Bottom Imagery having an imagery-type spatial representation and which is stored in UNISIPS file storage format. Data set 602 can then be processed by a data processing tool in the data processing system, with the output being data set 603, which has its own set of data specifications self-describing the data in data set 603 as being physical measurements comprising Roughness data having area-type spatial representation which are stored in a Shapefile file storage format. This final output data set 603 can then be output to a data analysis system such as ESRI arc 604.

Thus, the method of the present invention abstracts the execution of both external and internal processes, while providing a programming language-independent method to conduct run-time interface inspection for complex data types. Though this technique was developed to support geo-spatial data types stored as binary formatted files, the type specification system is easily extended to other problem domains.

There are few facilities in place to support this level of high-level context awareness either in programming language constructs or operating system-level features. Programming languages generally provide type-checking facilities for function invocation using basic data types such as integer, string, and real-valued number, or aggregations of these basic types as structures. The operating system itself gives the ability to name files. File suffixes are typically used as an indicator of what file's format is. However, it does not address the intrinsic properties that the data describes as does the method of the present invention.

It should be noted that one or more aspects of a system and method for self-describing data processing as described herein can be accomplished by one or more processors executing one or more sequences of one or more computer-readable instructions read into a memory of one or more computers from volatile or non-volatile computer-readable media capable of storing and/or transferring computer programs or computer-readable instructions for execution by one or more computers. Volatile media can include a memory such as a dynamic memory in a computer. Non-volatile computer readable media that can be used can include a compact disk, hard disk, floppy disk, tape, magneto-optical disk, PROM (EPROM, EEPROM, flash EPROM), SRAM, SDRAM, or any other magnetic medium; punch card, paper tape, or any other physical medium such as a chemical or biological medium.

Although particular embodiments, aspects, and features have been described and illustrated, it should be noted that the invention described herein is not limited to only those embodiments, aspects, and features. It should be readily appreciated that modifications may be made by persons skilled in the art, and the present application contemplates any and all modifications within the spirit and scope of the underlying invention described and claimed herein. For example, although the present invention has been described in terms of an exemplary set of data specifications and input/output specifications, it will be readily apparent to one skilled in the art that many other types of data specifications and input/output specifications are possible, and all such other types of data specifications and/or input/output specifications may be used as appropriate in the present invention. In addition, one skilled in the art would readily appreciate that the methodology described in the present disclosure generalizes to an arbitrary development environment and computer programming language, such as C++, Java, and Python. The scope of this methodology also generalizes to higher level architectures, from a desktop application to a networked service-oriented architecture. All such embodiments are also contemplated to be within the scope and spirit of the present disclosure.

What is claimed is:

1. A method for automatically identifying and selecting a compatible data set for processing by a data processing tool, comprising:
receiving, at a computer programmed to execute the data processing tool, a definition of the data processing tool, the definition including a set of self-described input specifications defining acceptable data that can be input into the data processing tool;
receiving, at the computer, a data set for processing by the data processing tool, the data set including a set of self-described data specifications defining the data in the data set;
comparing, at the computer, the data specifications of the data set to the input specifications of the data processing tool;
automatically accepting the data set for processing by the data processing tool only if all the data specifications of the data set are compatible with the input specifications of the data processing tool; and
automatically rejecting the data set if any of the data specifications of the data set are not compatible with the input specifications of the data processing tool.

2. The method according to claim 1, wherein the set of input specifications includes a specification of a physical measurement represented by the acceptable data, a specification of a geospatial representation of the physical measurement represented by the acceptable data, and a specification of a data storage format in which acceptable data can be stored; and wherein the data specifications include a physical measurement represented by the data in the data set, a geospatial representation of the physical measurement represented by the data, and a data storage format in which the data in the data set is stored on a storage medium.

3. The method according to claim 1, wherein the set of input specifications is incorporated into the definition of the data processing tool.

4. The method according to claim 1, wherein the set of input specifications is externalized as a portable configuration file operatively associated with the data processing tool.

5. The method according to claim 1, further comprising displaying an error message on a display operatively connected to the computer identifying the data specification of the data set that is not compatible with the input specifications of the data processing tool.

6. The method according to claim 1, wherein the data specifications are automatically assigned to the data set based on a source of the data in the data set.

7. The method according to claim 1, wherein the data processing tool further comprises a set of self-described output data specifications defining data that is output from the data processing tool.

8. The method for according to claim 7, wherein the set of output data specifications includes a specification of a physical measurement represented by the output data, a specification of a geospatial representation of the physical measurement represented by the output data, and a specification of a data storage format for storage of the output data.

9. The method according to claim 7, wherein the data set is accepted for processing by the data processing tool only if it can produce data compatible with the output specifications.

10. The method according to claim 7, wherein the data processing tool comprises a first data processing tool in an integrated data processing system comprising a plurality of data processing tools, wherein the data output from the first data processing tool comprises an output data set that is inspected for input into a second data processing tool, the second data processing tool having a corresponding definition including a set of second input specifications defining acceptable data that can be input into the second data processing tool.

11. The method according to claim 10, wherein the set of second input specifications includes a specification of a physical measurement represented by the acceptable data, a specification of a geospatial representation of the physical measurement represented by the acceptable data, and a specification of a data storage format in which the acceptable data can be stored; and
wherein the output data set from the first data processing tool can be accepted as input into the second data processing tool only if all the output data specifications of the output data set are compatible with the second input specifications of the second data processing tool.

12. A method for automatically integrating a plurality of data processing tools into an integrated data processing system, comprising:
receiving, at a computer programmed to operate the data processing system, definitions of a plurality of processing tools, each definition including a set of self-described input specifications defining acceptable data that can be input into the corresponding data processing tool;
receiving, at the computer, a data set for processing by the data processing system, the data set including a set of self-described data specifications defining the data in the data set;
comparing, at the computer, the data specifications of the data set to the input specifications of each of the plurality of the data processing tools in the data processing system; and
automatically selecting one of the plurality of data processing tools to process the data set, wherein the input specifications of the selected data processing tool are compatible with the data specifications of the data set.

13. The method according to claim 12, wherein each set of input specifications includes a specification of a physical measurement represented by the acceptable data, a specification of a geospatial representation of the physical measurement represented by the acceptable data, and a specification of a data storage format in which acceptable data can be stored; and wherein the data specifications include a physical measurement represented by the data in the data set, a geospatial representation of the physical measurement represented by the data, and a data storage format in which the data in the dataset is stored on a storage medium.

14. The method according to claim 12, wherein each set of input specifications is incorporated into the definition of the corresponding data processing tool.

15. The method according to claim 12, wherein each set of input specifications is externalized as a portable configuration file operatively associated with the corresponding data processing tool.

16. A method for automatically processing a data set in a data processing system, comprising:
receiving, at a computer programmed to execute the data processing tool, a definition of the data processing tool, the definition including a set of self-described input specifications defining acceptable data that can be input into the data processing tool;
receiving, at the computer, a data set for processing by the data processing tool, the data set including a set of self-described first data specifications defining the data in the data set;
comparing, at the computer, the first data specifications of the data set to the input specifications of the data processing tool; and
automatically converting at least one of the first data specifications into a corresponding second data specification if the first data specification is not compatible with the corresponding input specification, wherein the second data specification is compatible with the corresponding input specification of the data processing tool.

17. The method according to claim 16, wherein the set of input specifications includes a specification of a physical measurement represented by the acceptable data, a specification of a geospatial representation of the physical measurement represented by the acceptable data, and a specification of a data storage format in which acceptable data can be stored; and wherein the data specifications include a physical measurement represented by the data in the data set, a geospatial representation of the physical measurement represented by the data, and a data storage format in which the data in the dataset is stored on a storage medium.

18. The method according to claim 16, wherein the set of input specifications is incorporated into the definition of the data processing tool.

19. The method according to claim 16, wherein the set of input specifications is externalized as a portable configuration file operatively associated with the data processing tool.

20. The method according to claim 16, further wherein the conversion of the first data specification to the second data specification is performed by a second data processing tool interposed between an input of the data set and the first data processing tool.

21. A method for automatically processing a data set in a data processing system, comprising:
receiving, at a computer programmed to execute a data processing tool, a definition of the data processing tool, the definition including a set of self-describing input specifications defining acceptable data that can be input into the data processing tool;
receiving, at the computer, a data set for input into the data processing tool, the data set including a first self-described data specification defining at least one characteristic of data in the data set;
comparing, at the computer, the first data specification of the data set to the input specifications of the data processing tool;
automatically converting the first data specification into a second data specification if the first data characteristic is not compatible with the corresponding input specification of the data processing tool; and
automatically setting the values of other characteristics of the data in the data set based on the value of the second data specification, wherein the values of the characteristics of the data set comprise a set of data specifications compatible with the corresponding input specifications of the data processing tool.

22. The method according to claim 21, wherein the set of input specifications includes a specification of a physical measurement represented by the acceptable data, a specification of a geospatial representation of the physical measurement represented by the acceptable data, and a specification of a data storage format in which acceptable data can be stored; and wherein the defined data specification includes one of a physical measurement represented by the data in the data set, a geospatial representation of the physical measurement represented by the data, and a data storage format in which the data in the dataset is stored on a storage medium.

23. The method according to claim 21, wherein the set of input specifications is incorporated into the definition of the data processing tool.

24. The method according to claim 21, wherein the set of input specifications is externalized as a portable configuration file operatively associated with the data processing tool.

25. A data input tool for carrying out a method for receiving and inputting a data set into a data processing system, the data set including a set of self-described data specifications defining the data in the data set, comprising:
a data processing tool definition module, the data processing tool definition module including a set of self-described input specifications defining acceptable data that can be input into a data processing tool in the data processing system; and
a data inspection module configured to compare the data specifications of the data set to the input specifications of the data processing tool;
wherein the data set can be passed for processing by the data processing system only if all the data specifications of the data set are compatible with the input specifications of the data processing tool.

26. The data input tool according to claim 25, wherein the set of data specifications includes a physical measurement represented by the data in the data set, a geospatial representation of the physical measurement represented by the data, and a data storage format in which the data in the dataset is stored on a storage medium; and the set of input specifications includes a specification of a physical measurement represented by the acceptable data, a specification of a geospatial representation of the physical measurement represented by the acceptable data, and a specification of a data storage format in which acceptable data can be stored.

27. The data input tool according to claim 25, wherein the set of input specifications is incorporated into the definition of the data processing tool.

28. The data input tool according to claim 25, wherein the set of input specifications is externalized as a portable configuration file operatively associated with the data processing tool.
